(19) United States
(12) Patent Application Publication
(10) Pub. No.: US 2025/0337237 A1
(43) Pub. Date: Oct. 30, 2025

(54) SURGE PROTECTION DEVICE FOR WIRELESS COMMUNICATIONS

(71) Applicant: viaPhoton, Inc., Aurora, IL (US)

(72) Inventors: Walter Mark HENDRIX, Dallas, TX (US); Keith Samuel MARANTO, Frankfort, IL (US); Mark James SMRHA, Chicago, IL (US)

(21) Appl. No.: 19/193,581

(22) Filed: Apr. 29, 2025

Related U.S. Application Data
(60) Provisional application No. 63/640,172, filed on Apr. 29, 2024.

(51) Int. Cl. H02H 9/04

(52) U.S. Cl. CPC H02H 9/045

(57) ABSTRACT

A surge protection device (SPD) for protecting electrical circuits from transient overvoltage events is disclosed. The surge protection device includes an SPD base comprising a set of terminals and a set of slots electrically coupled to the terminals, and an SPD module comprising a housing, a set of pins configured to engage the slots, and a printed circuit board (PCB) bus contained within the housing. The PCB bus includes a first suppression circuit path and a second suppression circuit path. A suppression component is coupled to the first suppression circuit path. A switch is configured to automatically reconfigure the SPD from the first suppression circuit path to the second suppression circuit path upon failure of the suppression component. The SPD module may include a user-operable switch or jumper configured to select between a fail-open mode and a fail-closed mode. Redundant surge protection modules may be connected through a dual SPD base.

### CROSS-REFERENCE TO RELATED APPLICATIONS

This Application claims the benefit of U.S. Provisional Application Ser. No. 63/640,172, filed Apr. 29, 2024, which is hereby incorporated by reference for all purposes.

### BACKGROUND

Wireless communications systems rely on distributed infrastructure deployed across outdoor environments, including elevated towers, rooftop installations, and pole-mounted structures. Such systems typically include remote radio units, antenna assemblies, and associated power distribution components located at or near the top of the structure. Electrical power for these systems is commonly delivered using direct current (DC) circuits operating at voltages up to approximately 60 volts DC, with dedicated distribution units positioned at both the base and elevated portions of the tower. Power distribution systems for these applications must provide reliable, uninterrupted service while also mitigating transient overvoltage events caused by lightning strikes, switching surges, or other disturbances.

Surge protection devices (SPDs) have been deployed within outdoor wireless installations to suppress transient voltages and protect sensitive communication equipment. Conventional SPDs for these environments are typically based on plug-in module designs mounted onto DIN rails or directly within rack-mounted enclosures. Existing designs commonly use metal oxide varistors (MOVs) or gas discharge tubes (GDTs) to absorb surge energy. However, many traditional SPD designs rely on fixed circuit topologies without redundancy or failover mechanisms. In the event of component failure, the protection circuit either becomes open-circuited, leaving equipment unprotected, or short-circuited, risking additional system damage. Manual replacement of failed modules often requires downtime, specialized tools, or full disassembly of the distribution unit.

Prior SPD architectures also generally lack configurability to accommodate varying site layouts and system architectures. Systems requiring fail-open or fail-closed behaviors typically demand the installation of distinct SPD modules specifically tailored for each protection strategy. Furthermore, compactness is constrained by the need to separately mount multiple suppression components, resulting in larger form factors and increased conductor lengths between incoming power cables and suppression elements. Longer conductor paths can degrade voltage protection ratings (VPR) and increase the risk of differential surges damaging the protected equipment. A need therefore exists for modular, configurable surge protection systems that can maintain continuity during failure events, improve surge suppression performance, and support flexible deployment across diverse wireless communications infrastructures.

### SUMMARY

A surge protection device (SPD) is disclosed. The surge protection device includes an SPD base and an SPD module. The SPD base comprises a set of terminals configured for connection to input and output conductors, and a set of slots configured to receive a set of pins from the SPD module. The SPD module comprises a housing, a set of pins extending from the housing and configured for insertion into the set of slots to establish electrical connectivity with the SPD base, and a printed circuit board (PCB) bus contained within the housing. The PCB bus comprises a first suppression circuit path and a second suppression circuit path. A suppression component, such as a metal oxide varistor (MOV), gas discharge tube (GDT), or silicon avalanche suppressor diode (SASD), is coupled to the first suppression circuit path. At least one switch is provided within the SPD module and is configured to automatically reconfigure the SPD from the first suppression circuit path to the second suppression circuit path upon failure of the suppression component. In some embodiments, the switch comprises a spring-loaded blade connector released by melting of a fusible link.

In certain embodiments, the surge protection device includes a user-operable switch or jumper that is externally accessible and configured to allow the user to select between a fail-open configuration and a fail-closed configuration. The SPD module may be configured to operate in a 2+0 protection scheme or a 1+1 protection scheme without replacement of the PCB bus. A redundant surge protection configuration may also be provided, wherein a dual SPD base supports the connection of a primary SPD module and a redundant SPD module to provide continued surge protection in the event of primary suppression component failure. The physical arrangement of the suppression components and conductor connections within the SPD module is configured to minimize conductor lengths, improving voltage protection rating (VPR) performance during surge events. The system may be implemented within tower-mounted or rack-mounted wireless communications systems operating at voltages up to approximately 60VDC.

Other aspects of the invention will be apparent from the following description and the appended claims.

### BRIEF DESCRIPTION OF DRAWINGS

FIG. 1 shows a tower site in accordance with one or more embodiments of the invention.

FIG. 2A shows a tower base distribution unit in accordance with one or more embodiments of the invention.

FIG. 2B shows a tower mounted distribution unit in accordance with one or more embodiments of the invention.

FIGS. 3A and 3B show a surge protection device in accordance with one or more embodiments of the invention.

FIGS. 4A and 4B show a surge protection device in accordance with one or more embodiments of the invention.

FIG. 5 shows a surge protection device with housing partially removed in accordance with one or more embodiments of the invention.

FIGS. 6A and 6B show operation of a fusible link within a surge protection device in accordance with one or more embodiments of the invention.

FIGS. 7A and 7B are circuit diagrams of a surge protection device having a 2+0 configuration in accordance with one or more embodiments of the invention.

FIGS. 8A and 8B are circuit diagrams of a surge protection device having a 1+1 configuration in accordance with one or more embodiments of the invention.

FIGS. 9A and 9B are circuit diagrams of a surge protection device having a 2+0/1+1 selectable configuration in accordance with one or more embodiments of the invention.

FIGS. 10A and 10B are circuit diagrams of a surge protection device having a 2+0 configuration with redundancy in accordance with one or more embodiments of the invention.

FIGS. 11A and 11B are circuit diagrams of a surge protection device having a 1+1 configuration with redundancy in accordance with one or more embodiments of the invention.

Like elements in the various figures are denoted by like reference numerals for consistency.

### DETAILED DESCRIPTION

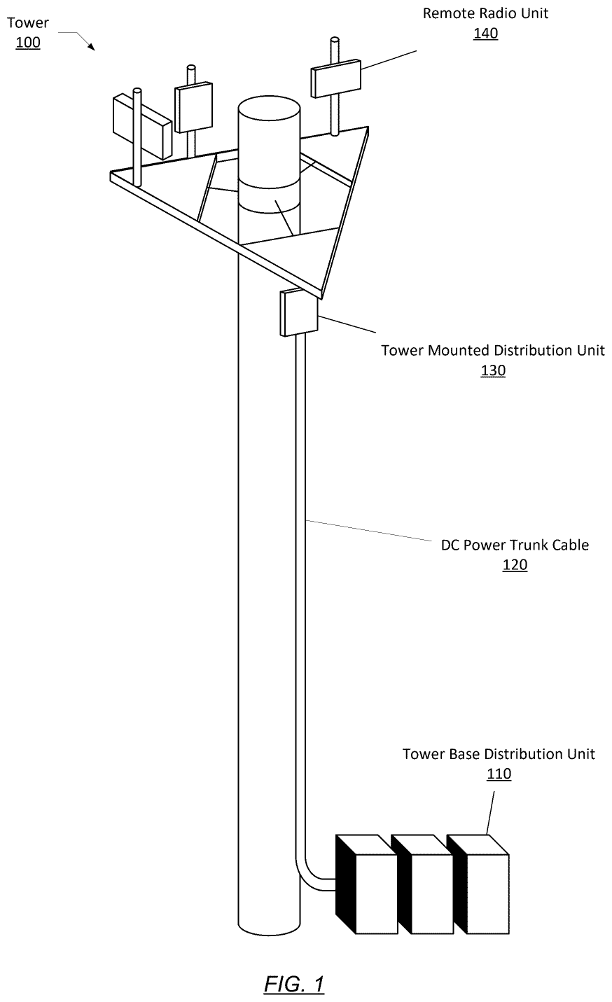

FIG. 1 shows a tower site in accordance with one or more embodiments of the invention. Tower site ((100)) configured to support a wireless communications system. The tower ((100)) is a vertical support structure configured to elevate wireless communications equipment to an elevated position. A tower base distribution unit ((110)) is positioned adjacent to the lower portion of the tower ((100)). The tower base distribution unit ((110)) is configured to receive electrical power from a source, such as an AC/DC rectifier or an outdoor power cabinet, and distribute DC power through associated surge protection devices (SPDs) located at or near the base of the tower ((100)).

A DC power trunk cable (120) extends vertically along the tower (100) from the tower base distribution unit (110) to a tower mounted distribution unit (130). The DC power trunk cable (120) provides electrical power to the elevated portions of the tower (100) and is configured to carry both positive and negative DC polarities. The DC power trunk cable (120) may comprise multiple conductors arranged in pairs, with each conductor pair corresponding to a separate radio circuit or group of circuits.

The tower mounted distribution unit (130) is attached to the tower (100) at an elevated position and is configured to distribute the DC power received from the DC power trunk cable (120) to one or more remote radio units (140) mounted at or near the top of the tower (100). The tower mounted distribution unit (130) may include surge protection devices mounted internally or externally to protect downstream components from electrical surges.

Remote radio units (140) are attached to the upper structure of the tower (100). The remote radio units (140) are wireless communications transceivers configured to transmit and receive wireless signals. Each remote radio unit (140) is electrically coupled to the tower mounted distribution unit (130) via dedicated power and communication links. The remote radio units (140) typically operate at elevated positions to maximize line-of-sight coverage and are vulnerable to electrical surges such as those caused by lightning strikes.

The tower (100) may also include ancillary components not explicitly labeled, such as mounting brackets, grounding conductors, communication cables, and cable management systems, which may interact with or support the operation of the DC power system and surge protection devices. The system configuration as shown supports modular deployment, redundancy, and surge protection consistent with the features of the claimed invention.

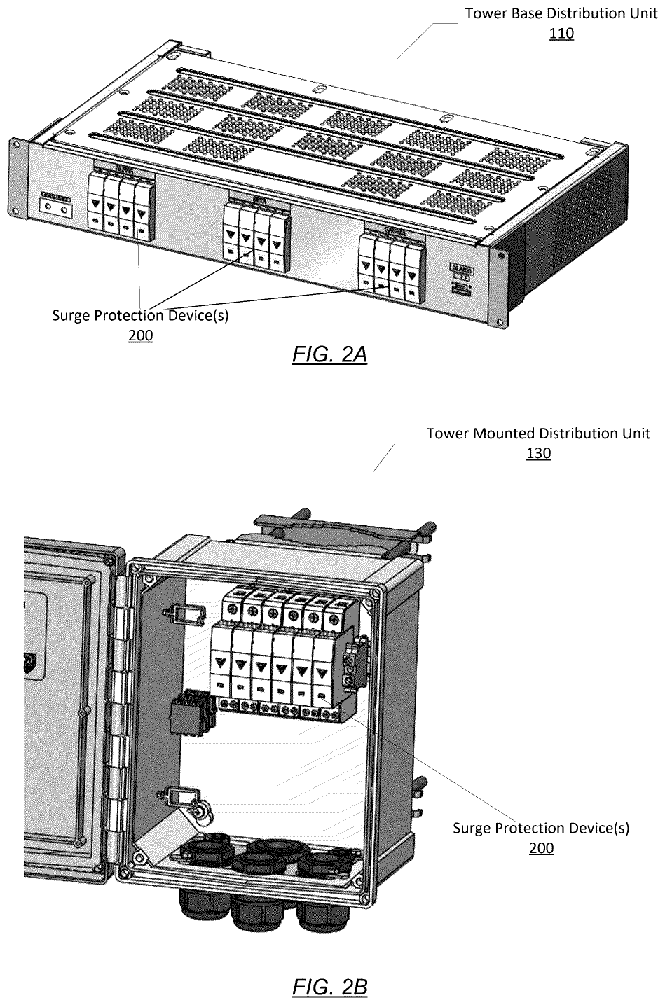

FIG. 2A shows a tower base distribution unit in accordance with one or more embodiments of the invention. Tower base distribution unit (110) configured to house multiple surge protection devices (SPDs) (200). The tower base distribution unit (110) is a rack-mounted enclosure typically located at or near the base of the tower (100). The enclosure provides mechanical protection, electrical connectivity, and surge protection for DC circuits supplying power to remote radio units positioned higher on the tower. The tower base distribution unit (110) is constructed to conform to a rack mounting standard, such as a 19-inch or 23-inch rack format, and occupies a height of approximately two rack units (2RU).

The surge protection devices (200) are arranged in modular positions along the front panel of the tower base distribution unit (110). The SPD modules are accessible from the front face of the tower base distribution unit (110), enabling field replacement or reconfiguration without full disassembly of the enclosure. The surge protection devices (200) are configured to protect the DC power circuits from transient voltage surges, such as those resulting from lightning strikes or switching events, and to maintain electrical continuity for critical wireless communication systems.

FIG. 2B shows a tower mounted distribution unit in accordance with one or more embodiments of the invention. Tower mounted distribution unit (130) configured to house multiple surge protection devices (200) at an elevated position on the tower (100). The tower mounted distribution unit (130) is an outdoor-rated enclosure designed for elevated installation and environmental exposure. The tower mounted distribution unit (130) receives DC power from the tower base distribution unit (110) via the DC power trunk cable (120) and redistributes the DC power to multiple remote radio units (140).

Within the tower mounted distribution unit (130), the surge protection devices (200) are installed along a mounting plate or DIN rail inside the enclosure. Each surge protection device (200) provides surge protection for an individual circuit or pair of conductors supplying power to a corresponding remote radio unit (140). The SPD base provides a set of terminals for input and output wiring, and the SPD module provides surge suppression functionality.

The tower mounted distribution unit (130) further includes cable entry points at the bottom of the enclosure to route input and output conductors. Additional features, such as grounding bars, mounting hardware, and environmental seals, may also be present.

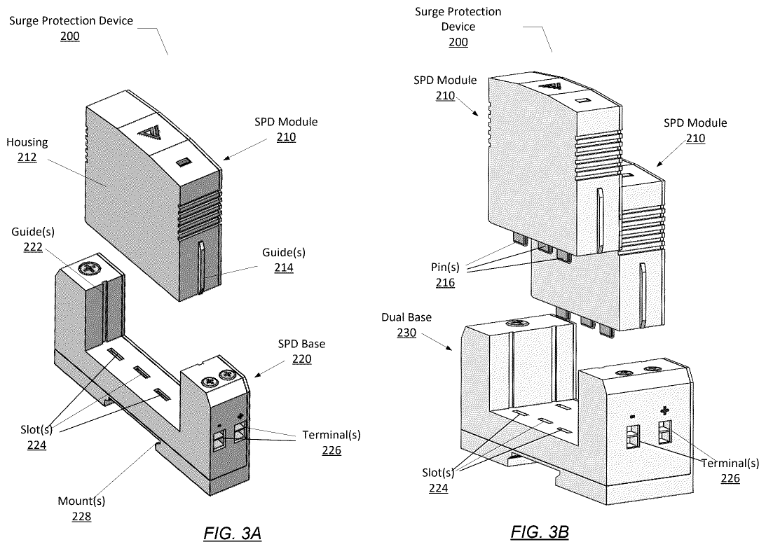

FIGS. 3A and 3B show a surge protection device in accordance with one or more embodiments of the invention. The surge protection device (200) comprises a surge protection module (210) that removably couples to a corresponding SPD base (220) or a dual SPD base (230).

In FIG. 3A, the surge protection module (210) includes a housing (212). The housing (212) is shaped to guide insertion and mechanical alignment into the SPD base (220) through one or more guides (214) formed on the exterior surface. The SPD module (210) is configured to house suppression components as described below.

The SPD base (220) is mountable to a fixed surface, such as a DIN rail or a mounting panel, using mounts (228) integrated into the structure of the SPD base (220). The SPD base (220) includes a set of slots (224) configured to receive corresponding pins extending from the SPD module (210). Electrical connectivity is established between the SPD module (210) and the SPD base (220) through insertion of the pins into the slots (224). The SPD base (220) further includes one or more terminals (226) configured to connect to external power conductors. Terminals (226) provide the points for coupling input power from a distribution unit or cable and output power to protected equipment.

In FIG. 3B, the surge protection device (200) is shown with a dual base (230) configuration. The dual base (230) is configured to accommodate two SPD modules (210) simultaneously. Each SPD module (210) includes a set of pins (216) extending from the housing (212). The pins (216) are configured for insertion into corresponding slots (224) of the dual base (230), thereby establishing electrical contact. The dual base (230) enables interconnection between two SPD modules (210) to form a redundant protection configuration, wherein failure of a primary SPD module results in activation of a redundant SPD module without user intervention.

Each SPD module (210) inserted into either an SPD base (220) or a dual base (230) forms an operative surge protection assembly. The SPD module (210), upon insertion, is retained in position via mechanical engagement between the guides (214) and corresponding slots or features in the SPD base (220) or dual base (230). Electrical connectivity through the pins (216) and slots (224) establishes the active protection circuits, including the first suppression circuit path and the second suppression circuit path described in the claims. Upon occurrence of an overvoltage event leading to suppression component failure, a spring-loaded blade connector, activated by melting of a fusible link, reconfigures the circuit from the first suppression circuit path to the second suppression circuit path or to an alternative ground path.

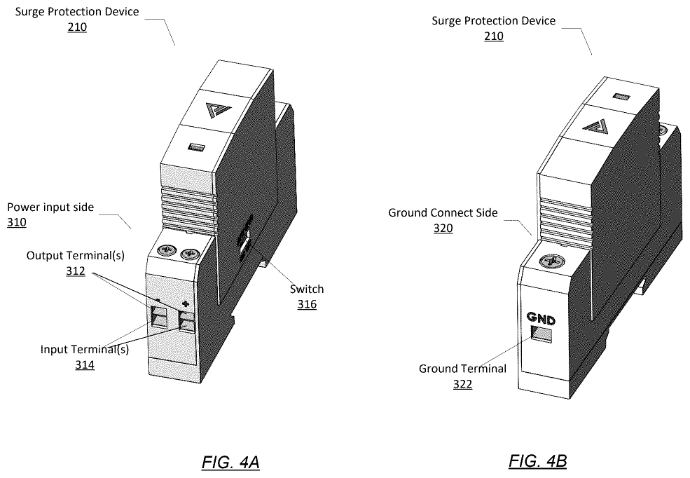

FIGS. 4A and 4B show a surge protection device in accordance with one or more embodiments of the invention. The surge protection device (210) comprises a modular assembly configured to provide surge protection for DC power circuits, particularly for wireless communication applications operating up to approximately 60VDC.

In FIG. 4A, the power input side (310) of the surge protection device (210) is shown. The power input side (310) includes a set of output terminals (312) and a set of input terminals (314). The input terminals (314) are configured to receive input power from an upstream distribution system, such as the tower base distribution unit (110) or tower mounted distribution unit (130). Each input terminal (314) provides an electrical connection for either positive or negative DC polarity conductors. The output terminals (312) are configured to provide surge-protected power output to downstream equipment, such as remote radio units (140).

Also located on the power input side (310) is a switch (316). The switch (316) is a user-operable feature configured to allow manual selection between a fail-open mode and a fail-closed mode. In the fail-open mode, a failure of a suppression component results in disconnection of the circuit. In the fail-closed mode, a failure of a suppression component triggers a spring-loaded blade connector to establish an alternative conductive path, maintaining circuit continuity. The switch (316) may be externally accessible without disassembling the SPD module (210) and may be tamper-resistant or require a tool for operation.

In FIG. 4B, the ground connect side (320) of the surge protection device (210) is illustrated. The ground connect side (320) includes a ground terminal (322). The ground terminal (322) is configured to provide a secure connection to a protective earth ground (PE GND) or equipment grounding bar. During normal operation, surge current is directed through suppression components to the ground terminal (322) when overvoltage events occur. Upon failure of a suppression component and activation of the switch mechanism, the ground terminal (322) provides a low-resistance path for diverted surge current, either via the second suppression circuit path or via an alternative short-to-ground path.

The relative arrangement of the input terminals (314), output terminals (312), and ground terminal (322) supports close coupling of incoming and outgoing power conductors within approximately 25 millimeters of the surge suppression components. This arrangement reduces line-to-line voltage differentials during surge events, improves voltage protection rating (VPR), and enhances the overall performance of the surge protection device (210).

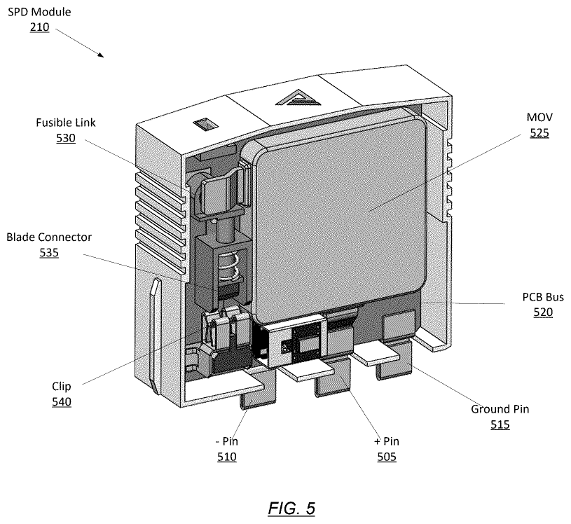

FIG. 5 shows a surge protection device with housing partially removed in accordance with one or more embodiments of the invention. FIG. 5 illustrates a surge protection device (SPD) module (210) with the housing partially removed to expose internal components in accordance with one or more embodiments.

A positive pin (505), a negative pin (510), and a ground pin (515) extend downward from the SPD module (210). These pins are configured to be inserted into corresponding slots in an SPD base (220) or dual base (230) to establish electrical connections between the module and the external power and grounding circuits. The positive pin (505) carries positive polarity DC voltage, the negative pin (510) carries negative polarity DC voltage, and the ground pin (515) provides an electrical connection to earth ground.

A printed circuit board (PCB) bus (520) is mounted internally within the SPD module (210). The PCB bus (520) contains electrical traces forming a first suppression circuit path and a second suppression circuit path. These paths are configured to route surge currents through selected suppression components depending on operational status and the occurrence of a fault event.

Mounted to the PCB bus (520) is a metal oxide varistor (MOV) (525). The MOV (525) functions as a primary suppression component, configured to absorb transient overvoltage surges between input power lines and ground. Upon exposure to a surge above a defined voltage threshold, the MOV (525) conducts current to limit the voltage let through to protected equipment. In alternative embodiments, additional or alternative suppression components, such as gas discharge tubes (GDTs) or silicon avalanche suppressor diodes (SASDs), may be coupled to the PCB bus (520).

Positioned adjacent to the MOV (525) is a fusible link (530). The fusible link (530) is configured to melt or separate upon failure of the MOV (525) or excessive heating, signaling the activation of an alternative suppression or failover path. The fusible link (530) is mechanically coupled to a spring-loaded blade connector (535). Upon melting of the fusible link (530), the stored spring force propels the blade connector (535) into engagement with a clip (540).

The blade connector (535) and clip (540) assembly operates as an automatic switching mechanism. Upon actuation, the blade connector (535) inserts into the clip (540) to complete an alternative conductive path. Depending on the configuration selected by a user-operable switch or jumper, the alternative conductive path may connect the input power line directly to ground, thereby achieving a fail-closed configuration, or may disable conduction to create a fail-open condition.

The configuration of components within the SPD module (210) supports fast response to failure events. The actuation of the blade connector (535) upon fusible link (530) melting occurs within a timespan of less than approximately (100) milliseconds. This response time enables continued surge protection or isolation of the circuit as needed without manual intervention.

The relative physical positioning of the positive pin (505), negative pin (510), and ground pin (515) in close proximity to the MOV (525) reduces the distance between incoming power connections and suppression elements to less than 25 millimeters. This compact arrangement minimizes line-to-line voltage differentials during transient events and enhances the voltage protection rating (VPR) performance of the surge protection device (210).

The structure illustrated in FIG. 5 enables the SPD module (210) to be field-replaceable, modular, and reconfigurable for different operational modes, including 2+0 and 1+1 protection configurations, without replacement of the PCB bus (520). The integration of automatic switching elements, redundant suppression paths, and high-density suppression components supports application within tower-mounted and rack-mounted wireless communication power systems.

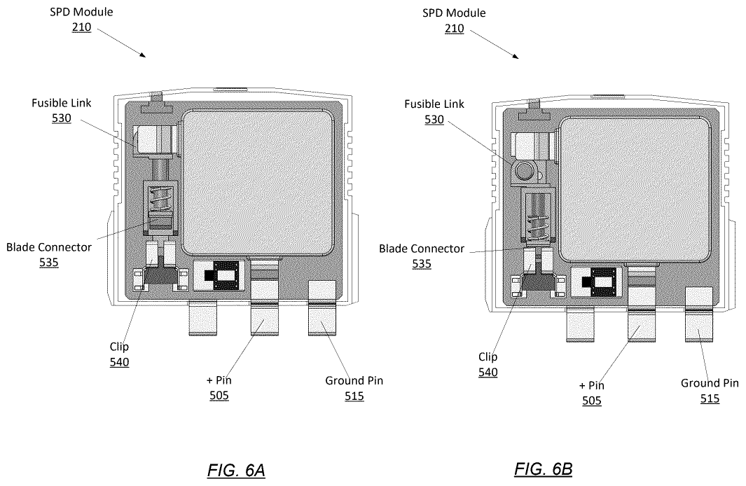

FIGS. 6A and 6B show operation of a fusible link within a surge protection device in accordance with one or more embodiments of the invention. The internal structures are shown in cross-sectional views with the housing removed for clarity.

In FIG. 6A, the fusible link (530) is in an intact state. The fusible link (530) provides mechanical restraint to a spring-loaded blade connector (535). The blade connector (535) remains in a retracted position under spring tension, disconnected from a corresponding clip (540). The clip (540) is a fixed conductive structure mounted within the SPD module (210) and configured to receive the blade connector (535) upon release. The positive pin (505), ground pin (515), and negative pin (not labeled separately in this view) extend downward from the SPD module (210) to provide electrical connectivity between the SPD module and an external SPD base.

The fusible link (530) is thermally coupled to the primary suppression component, such as a metal oxide varistor (MOV) (525) (previously shown in FIG. 5). Upon exposure to an overvoltage surge that exceeds the suppression capacity of the MOV (525), or under thermal runaway conditions, the fusible link (530) is configured to melt or sever due to excessive heat.

In FIG. 6B, the fusible link (530) has melted or separated. Upon melting, the stored spring force propels the blade connector (535) into mechanical and electrical engagement with the clip (540). The connection between the blade connector (535) and the clip (540) completes an alternative circuit path. Depending on the operational mode configured via a user-operable switch or jumper on the exterior of the SPD module (210), the alternative path may either provide a fail-closed path to ground (preserving continuity) or simply disconnect the circuit to create a fail-open condition.

The proximity of the fusible link (530), blade connector (535), and clip (540) ensures that the switching operation occurs rapidly following the thermal failure event, typically in less than (100) milliseconds. The quick engagement of the blade connector (535) minimizes the window during which protected circuits may be exposed to surge energy without active suppression.

The arrangement of the positive pin (505) and ground pin (515) remains consistent between FIGS. 6A and 6B, enabling the SPD module (210) to maintain physical and electrical interface standards with the SPD base. The architecture supports field serviceability, modular replacement, and operational reconfiguration without replacement of the PCB bus internal to the SPD module (210).

The blade connector (535) and clip (540) switching mechanism described herein enables the surge protection device to automatically reconfigure between a first suppression circuit path and a second suppression circuit path, or to establish a direct alternative path to ground upon failure of a primary suppression component.

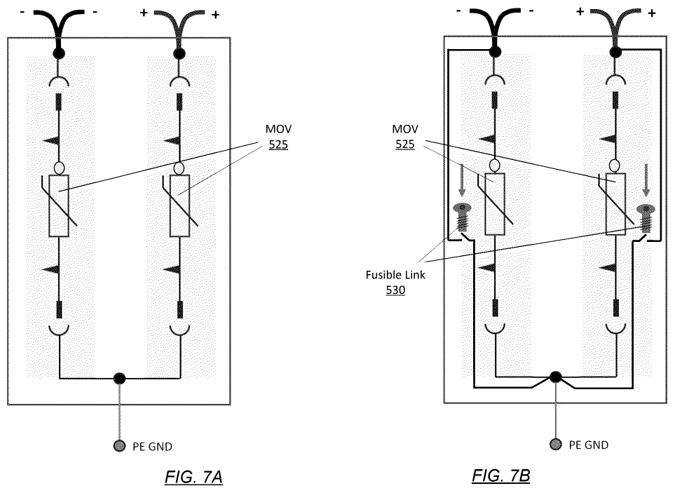

FIGS. 7A and 7B are circuit diagrams of a surge protection device having a 2+0 configuration in accordance with one or more embodiments of the invention. The 2+0 configuration provides surge protection across two DC polarity lines without reliance on a dedicated neutral line. Each DC polarity line is protected independently through parallel surge suppression circuits.

In FIG. 7A, the surge protection device is shown operating in a fail-open mode. The two power input lines are identified by their respective polarities: a negative polarity input line (black) and a positive polarity input line (red). Each input line is electrically connected to a corresponding surge suppression circuit that includes a metal oxide varistor (MOV) (525) connected between the respective input line and protective earth ground (PE GND).

Each MOV (525) is configured to conduct current to PE GND upon detection of an overvoltage event. The normal operational current path does not involve conduction through the MOV (525) unless a transient voltage exceeds a predetermined threshold. In this fail-open configuration, each MOV (525) is further protected by a fusible link (530). Upon excessive thermal energy absorption by a MOV (525), the associated fusible link (530) melts, interrupting the circuit path to prevent continued conduction or damage. In the fail-open arrangement, no additional switching mechanism closes the circuit after fusible link activation, resulting in an open circuit condition at the failed surge suppression path.

FIG. 7B illustrates the same surge protection device configured to operate in a fail-closed mode. The circuit topology remains similar to FIG. 7A with two independent surge suppression circuits protecting the positive and negative DC input lines. Each circuit again includes a MOV (525) and a fusible link (530). However, in this configuration, a spring-loaded blade connector (not explicitly shown in the diagram but previously illustrated in mechanical figures) is positioned to close the circuit automatically upon melting of the fusible link (530).

When a MOV (525) fails or overheats, the corresponding fusible link (530) melts, releasing the spring-loaded blade connector, which then engages and closes an alternative conductive path to ground. This fail-closed action ensures that surge protection is maintained even after failure of the initial suppression component. The alternative conductive path diverts transient energy from the affected input line to PE GND, preserving system continuity.

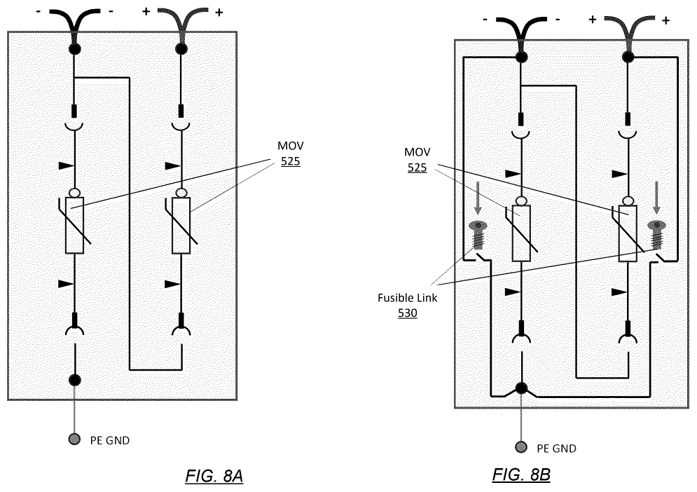

FIGS. 8A and 8B are circuit diagrams of a surge protection device having a 1+1 configuration in accordance with one or more embodiments of the invention. In the 1+1 configuration, each conductor—both positive and negative polarity—is protected by its own independent surge suppression path, and the positive and negative sides are isolated from one another.

In FIG. 8A, the surge protection device is depicted operating in a fail-open mode. A negative polarity input line (black) and a positive polarity input line (red) enter the SPD module and are routed through respective suppression circuits. Each suppression circuit includes a metal oxide varistor (MOV) (525) coupled between the corresponding input line and a protective earth ground (PE GND). The MOV (525) in each path is configured to conduct current to ground only upon detection of a voltage transient exceeding a predetermined voltage threshold.

Each MOV (525) is protected by a corresponding fusible link (530) (not separately shown in this figure but known from earlier descriptions). Under normal operation, the fusible link (530) remains intact, and surge energy is directed through the MOV (525). If a MOV (525) absorbs excessive surge energy or undergoes a thermal failure, the associated fusible link (530) melts, disconnecting the failed suppression path and resulting in an open circuit condition between the respective input line and ground. In the fail-open mode, no alternative path to ground is established following failure, preserving circuit isolation.

In FIG. 8B, the surge protection device is shown operating in a fail-closed mode. The same input arrangement applies, with the negative polarity line (black) and positive polarity line (red) entering the SPD module. Each suppression circuit again includes a MOV (525) electrically coupled between the input conductor and PE GND. Each MOV (525) is protected by a fusible link (530), shown diagrammatically in FIG. 8B adjacent to each MOV (525).

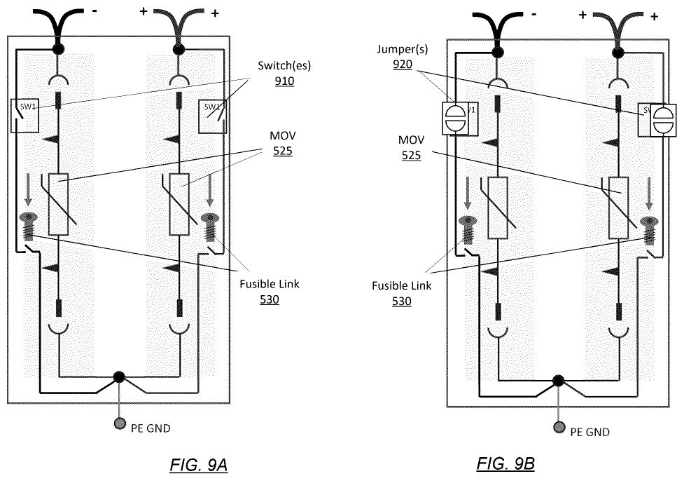

FIGS. 9A and 9B are circuit diagrams of a surge protection device having a 2+0/1+1 selectable configuration in accordance with one or more embodiments of the invention. The selectable configuration permits a user to modify the protection scheme to accommodate different system designs without replacement of the SPD module hardware.

In FIG. 9A, the selectable configuration is achieved using switches (910). A negative polarity input (black) and a positive polarity input (red) are received by the SPD module. Each input conductor connects to a corresponding surge suppression circuit including a metal oxide varistor (MOV) (525) coupled to protective earth ground (PE GND). Each MOV (525) is configured to conduct transient surge energy from its associated input line to ground when an overvoltage event exceeds a predetermined threshold.

Each suppression circuit further includes a fusible link (530) coupled to a spring-loaded blade connector (not shown, but described in earlier figures). Under normal conditions, the fusible link (530) remains intact, and the MOV (525) provides the primary suppression path. Upon excessive heating or failure of the MOV (525), the fusible link (530) melts, allowing the blade connector to activate and complete an alternative conduction path.

The switches (910) are incorporated between the input conductors and the surge suppression circuits. In one configuration, the switches (910) can be set to connect the input conductors to their respective MOV (525) circuits individually, maintaining a 1+1 protection configuration where positive and negative inputs are isolated and independently protected. Alternatively, the switches (910) can be set to interconnect the two input conductors internally, enabling a 2+0 protection configuration where both conductors are tied together for symmetrical protection to ground.

In FIG. 9B, the selectable configuration is achieved using jumpers (920) instead of switches. The jumpers (920) are removable or repositionable conductive links that perform the same function as the switches (910), but are intended for less frequent reconfiguration, such as during installation or maintenance. The placement of the jumpers (920) establishes either independent paths (1+1 configuration) or interconnected paths (2+0 configuration) between the positive and negative inputs and the suppression circuits.

In both FIGS. 9A and 9B, the surge suppression circuits include MOVs (525) that are protected by fusible links (530). Upon activation of the spring-loaded blade connector following fusible link failure, a low-resistance path to PE GND is established, ensuring continued surge protection even after the primary MOV device has failed. The selectable configuration allows the same SPD module to be deployed in different system architectures by configuring either the switch (910) or jumper (920) positions.

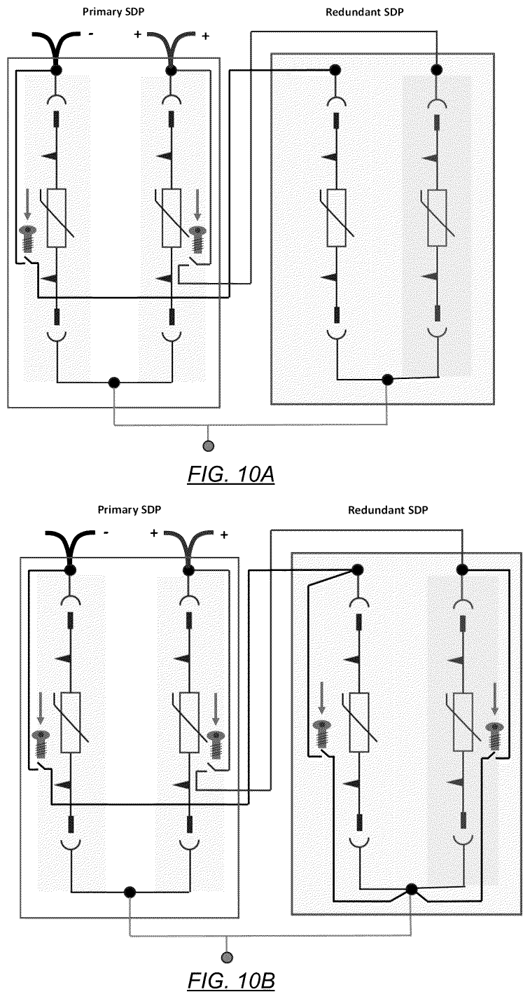

FIGS. 10A and 10B are circuit diagrams of a surge protection device having a 2+0 configuration with redundancy in accordance with one or more embodiments of the invention. The system includes a primary SPD module, and a redundant SPD module interconnected to provide continuous surge protection even after failure of the primary module.

In FIG. 10A, the negative polarity input (black) and the positive polarity input (red) are received at the primary SPD module. Each input conductor is connected to an independent surge suppression circuit within the primary SPD module. Each suppression circuit includes a metal oxide varistor (MOV) (525) configured to conduct transient surge energy to protective earth ground (PE GND) when the input voltage exceeds a defined threshold. Each MOV (525) is protected by a fusible link (530) coupled to a spring-loaded blade connector (not explicitly shown but previously described). Under normal conditions, the fusible link (530) remains intact, and surge current is diverted through the MOV (525) to ground during transient events.

The redundant SPD module is electrically connected in parallel with the primary SPD module. Each corresponding input conductor (positive and negative) is routed to a corresponding suppression circuit in the redundant SPD module. During normal operation, the primary SPD module provides the active surge protection, and the redundant SPD module remains electrically coupled but non-conductive under normal surge levels.

Upon failure of the primary SPD module—specifically, melting of the fusible link (530) and actuation of the blade connector—the circuit path through the redundant SPD module becomes active. The redundant SPD module thus maintains surge protection for the corresponding input conductor, preserving the protective function without interruption.

In FIG. 10B, the system is shown with both the primary SPD module and the redundant SPD module operating in a fail-closed configuration. The negative and positive polarity inputs again connect to the primary SPD module. Each suppression circuit includes a MOV (525) and a fusible link (530). Upon failure of a MOV (525) in the primary SPD module, the associated fusible link (530) melts, triggering the spring-loaded blade connector to close an alternative conductive path to PE GND. Simultaneously, the redundant SPD module is configured to activate and provide an additional conduction path, maintaining system continuity.

The redundant SPD module includes identical suppression circuits for the positive and negative inputs, with MOVs (525) and fusible links (530) arranged in the same topology as in the primary SPD module. The electrical interconnection between the primary and redundant SPD modules ensures that surge energy continues to be diverted to ground even after suppression failure in the primary device.

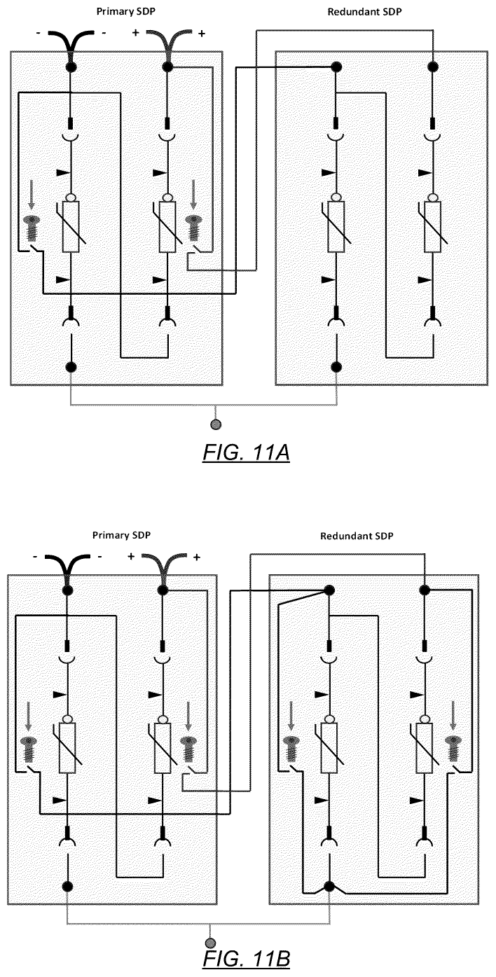

FIGS. 11A and 11B are circuit diagrams of a surge protection device having a 1+1 configuration with redundancy in accordance with one or more embodiments of the invention. The system includes a primary SPD module, and a redundant SPD module electrically interconnected to maintain surge protection upon failure of the primary module.

In FIG. 11A, the system is configured to operate in a fail-open mode. A negative polarity input (black) and a positive polarity input (red) are each routed to independent surge suppression circuits within the primary SPD module. Each suppression circuit includes a metal oxide varistor (MOV) (525) electrically coupled between the input conductor and a protective earth ground (PE GND). Each MOV (525) is protected by a fusible link (530) coupled to a spring-loaded blade connector (not shown but previously described). During normal operation, the fusible links (530) remain intact, and each MOV (525) conducts surge energy to ground upon occurrence of transient events exceeding a defined voltage threshold.

In the event of MOV (525) failure within the primary SPD module, the corresponding fusible link (530) melts, causing an open circuit on the affected suppression path. The redundant SPD module is connected to the same input conductors through separate suppression circuits. Each suppression path in the redundant SPD module includes a MOV (525) and a fusible link (530). Upon failure of the primary SPD module suppression path, the corresponding redundant suppression circuit remains available to maintain surge protection by conducting subsequent surge energy to ground.

In FIG. 11B, the system is configured to operate in a fail-closed mode. The input arrangement remains the same, with the negative polarity input (black) and positive polarity input (red) supplied to the primary SPD module. Each suppression circuit includes a MOV (525) and a fusible link (530) coupled to a spring-loaded blade connector. Upon MOV (525) failure and melting of the fusible link (530), the blade connector engages, completing an alternative conductive path to PE GND to maintain protection without opening the circuit. Simultaneously, the redundant SPD module is configured to activate and provide a second conductive path, preserving system continuity and redundancy.

The redundant SPD module replicates the primary SPD module structure, including MOVs (525) and fusible links (530), arranged independently for the positive and negative input lines. Upon activation, the redundant circuits provide a direct connection between each input conductor and PE GND.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A surge protection device (SPD) comprising:
an SPD base comprising:
a set of terminals; and
a set of slots electrically coupled to the set of terminals;
an SPD module comprising:
a housing;
a set of pins, extending from the housing and insertable into the set of slots to provide electrical connectivity between the SPD base and the SPD module;
a printed circuit board (PCB) bus contained within the housing and comprising a first suppression circuit path and a second suppression circuit path;
a first suppression component coupled to the first suppression circuit path,
at least one switch that automatically reconfigures the SPD from the first suppression circuit path to the second suppression circuit path upon failure the first suppression component.

2. The surge protection device of claim 1, wherein the SPD base is sized to fit within a width of a standard DIN rail module.

3. The surge protection device of claim 1, wherein the SPD is mountable within a tower-mounted enclosure or a rack-mounted enclosure having a 2RU form factor.

4. The surge protection device of claim 1, wherein the SPD module is configured for use in wireless communications systems operating at a nominal DC voltage of up to approximately 60VDC.

5. The surge protection device of claim 1, wherein incoming power connections are located within 25 millimeters of the suppression components.

6. The surge protection device of claim 4, wherein the SPD module is configured to reduce a line-to-line voltage differential during a surge events.

7. The surge protection device of claim 1, wherein the surge suppression components further comprise:
at least two components selected from the group consisting of metal oxide varistors (MOVs), gas discharge tubes (GDTs), and silicon avalanche suppressor diodes (SASDs)

8. The surge protection device of claim 1, wherein the switch further comprises:
a spring-loaded blade connector released by a fusible link.

9. The surge protection device of claim 8, wherein the switch provides an alternative path to ground upon failure of the first suppression component.

10. The surge protection device of claim 8, wherein the switch is configured to switch to the alternative path to ground to ground in less than (100) milliseconds after activation of the spring-loaded blade connector.

11. The surge protection device of claim 1, wherein the SPD module is reconfigurable to operate in a 2+0 configuration or a 1+1 configuration without replacement of the PCB bus.

12. The surge protection device of claim 1, wherein the SPD module further comprises:
a user-operable switch or jumper externally accessible on the SPD module to selectively configure the SPD between a fail-open mode and a fail-closed mode upon failure of the primary surge suppression circuit.

13. The surge protection device of claim 10, wherein the user-operable switch is configured to be accessed without disassembling the SPD module.

14. A surge protection device (SPD) module comprising:
a housing;
a set of pins, extending from the housing and insertable into the set of slots to provide electrical connectivity between the SPD module and an SPD base;
a printed circuit board (PCB) bus contained within the housing and comprising a first suppression circuit path and a second suppression circuit path;
a first suppression component coupled to the first suppression circuit path,
at least one switch that automatically reconfigures the SPD from the first suppression circuit path to the second suppression circuit path upon failure the first suppression component.

15. The SPD module of claim 14, wherein the surge suppression components further comprise:
at least two components selected from the group consisting of metal oxide varistors (MOVs), gas discharge tubes (GDTs), and silicon avalanche suppressor diodes (SASDs)

16. The SPD module of claim 14, wherein the switch further comprises:
a spring-loaded blade connector released by a fusible link that provides an alternative path to ground upon failure of the first suppression component.

17. The SPD module of claim 16, wherein the switch is configured to switch to the alternative path to ground to ground in less than (100) milliseconds after activation of the spring-loaded blade connector.

18. The SPD module of claim 14, wherein the SPD module is reconfigurable to operate in a 2+0 configuration or a 1+1 configuration without replacement of the PCB bus.

19. The SPD module of claim 14, wherein the SPD module further comprises:
a user-operable switch or jumper externally accessible on the SPD module to selectively configure the SPD between a fail-open mode and a fail-closed mode upon failure of the primary surge suppression circuit.

20. A surge protection device (SPD) comprising:
a dual SPD base comprising:
a set of terminals;
a first set of slots electrically coupled to the set of terminals; and
a second set of slots electrically coupled to the set of terminals;
a plurality of SPD modules, each SPD module comprising:
a housing;
a set of pins, extending from the housing and insertable into the set of slots to provide electrical connectivity between the SPD base and the SPD module;
a printed circuit board (PCB) bus contained within the housing and comprising a first suppression circuit path and a second suppression circuit path;
a first suppression component coupled to the first suppression circuit path,
at least one switch that automatically reconfigures the SPD from the first suppression circuit path to the second suppression circuit path upon failure the first suppression component.
